(19) United States
(12) Patent Application Publication
(10) Pub. No.: US 2019/0309971 A1
(43) Pub. Date: Oct. 10, 2019

(54) SYSTEMS AND METHODS FOR DYNAMICALLY GENERATING BARCODES TO IDENTIFY HVAC SYSTEM FAULTS

(71) Applicant: Johnson Controls Technology Company, Auburn Hills, MI (US)

(72) Inventors: Jonathan A. Burns, Wichita, KS (US); Theresa N. Gillette, Wichita, KS (US); Tyler P. McCune, El Dorado, KS (US)

(21) Appl. No.: 15/957,697

(22) Filed: Apr. 19, 2018

Related U.S. Application Data
(60) Provisional application No. 62/652,752, filed on Apr. 4, 2018.

(51) Int. Cl. F24F 11/38; F24F 11/52; F24F 11/56; F24F 11/64; G06K 19/06; G06K 7/10; G06K 7/14; G05B 19/042; G06Q 10/00

(52) U.S. Cl. CPC F24F 11/38; F24F 11/52; F24F 11/56; F24F 11/64; G05B 2219/2614; G06K 7/10722; G06K 7/1417; G05B 19/042; G06Q 10/20; G06K 19/06037

(57) ABSTRACT

The present disclosure includes systems and methods that facilitate quickly and conveniently addressing faults experienced by conditioned air equipment by dynamically generating a barcode on a thermostat. In some embodiments, the thermostat includes fault determination logic that determines that the conditioned air equipment is experiencing a fault and barcode generation logic that generates a barcode based on the fault. The authorized service personnel may scan the barcode using a mobile device and receive information about the fault. In this manner, the dynamically generated barcode may be used to quickly and conveniently address faults of the conditioned air equipment, repair the conditioned air equipment, perform maintenance on the conditioned air equipment, and the like.

### CROSS REFERENCE TO RELATED APPLICATIONS

This application claims priority from and benefit of U.S. Provisional Application Ser. No. 62/652,752 filed Apr. 4, 2018, entitled “Systems and Methods for Dynamically Generating Barcodes to Identify HVAC System Faults,” which is hereby incorporated by reference in its entirety for all purposes.

### BACKGROUND

The present disclosure generally relates to addressing faults of a heating, ventilation, and air conditioning (HVAC) system, and more particularly to dynamically generating a barcode on a thermostat to identify the faults.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Faults may occur in an HVAC system during normal operation. In particular, a component, such as a sensor, of the HVAC system may begin operating improperly or cease operating completely. In such cases, a homeowner may contact authorized service personnel to repair the HVAC system to clear the fault and restore the HVAC system to a properly running status. Typically, the authorized service personnel may perform a tedious and inefficient process of examining the HVAC system to determine where the fault occurred and for which component the fault occurred in. In some cases, the authorized service personnel may refer to his records to determine fault history and/or maintenance history of the component.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a thermostat includes fault determination logic that determines that conditioned air equipment is experiencing a fault. The thermostat also includes barcode generation logic programmed to generate a barcode based on the fault. The thermostat further includes an electronic display that displays the barcode to facilitate communicating information related to the fault with an external device when the barcode is scanned by the external device.

In another embodiment, a method for determining a fault in conditioned air equipment includes receiving an indication of a fault occurring in the conditioned air equipment. The method also includes generating a barcode based on parameters of the fault. The method further includes displaying the barcode to enable determining the parameters of the fault when the barcode is scanned.

In yet another embodiment, a tangible, non-transitory, machine-readable medium stores instructions executable a processor of a thermostat that, when executed by the processor, cause the processor to receive an indication of a fault occurring in a component of conditioned air equipment. The instructions also cause the processor to generate a barcode based on the component of the conditioned air equipment, parameters of the fault occurring in the component, or both. The instructions further cause the processor to display the barcode to enable determining the component experiencing the fault, the parameters of the fault, or both, in response to scanning the barcode.

### BRIEF DESCRIPTION OF THE DRAWINGS

Various aspects of the present disclosure may be better understood upon reading the following detailed description and upon reference to the drawings, in which:

FIG. 1 illustrates a heating, ventilating, and air conditioning (HVAC) system for building environmental management that may employ one or more HVAC units, in accordance with an embodiment of the present disclosure;

FIG. 2 is a perspective view of a HVAC unit of the HVAC system of FIG. 1, in accordance with an embodiment of the present disclosure;

FIG. 3 illustrates a residential heating and cooling system, in accordance with an embodiment of the present disclosure;

FIG. 4 illustrates a vapor compression system that may be used in the HVAC system of FIG. 1 and in the residential heating and cooling system of FIG. 3, in accordance with an embodiment of the present disclosure;

FIG. 5 is a block diagram of a system that dynamically generates a barcode for installing a thermostat and/or addressing faults in an HVAC system, in accordance with an embodiment of the present disclosure;

FIG. 6 is an example of a mobile device scanning a barcode displayed on a display of the thermostat of FIG. 5, in accordance with an embodiment of the present disclosure;

FIG. 7 is a flow diagram of a process for installing the thermostat of FIG. 5 by dynamically generating a barcode, in accordance with an embodiment of the present disclosure; and

FIG. 8 is a flow diagram of a process for indicating faults of the HVAC system of FIG. 5 by dynamically generating a barcode, in accordance with an embodiment of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

A barcode dynamically generated by a thermostat communicatively coupled to a heating, ventilation, and air conditioning (HVAC) system may include information relevant to a fault experienced by the HVAC system much more quickly than tediously examining the HVAC system to determine where the fault occurred and which component suffered the fault. Moreover, the dynamically generated barcode may include information that would normally be unavailable to the authorized service personnel without time-consuming research, such as warranty information of the component, operational characteristics of the component, maintenance history of the component, and the like.

The present disclosure provides techniques to facilitate quickly and conveniently addressing faults experienced by an HVAC system by dynamically generating a barcode on a thermostat communicatively coupled to the HVAC system. In some embodiments, the thermostat includes fault determination logic that determines that the HVAC system is experiencing a fault and barcode generation logic that generates a barcode based on the fault. The authorized service personnel may scan the barcode using a mobile device and receive information about the fault. In this manner, the dynamically generated barcode may be used to quickly and conveniently address faults of the HVAC system, repair the HVAC system, perform maintenance on the HVAC system, and the like.

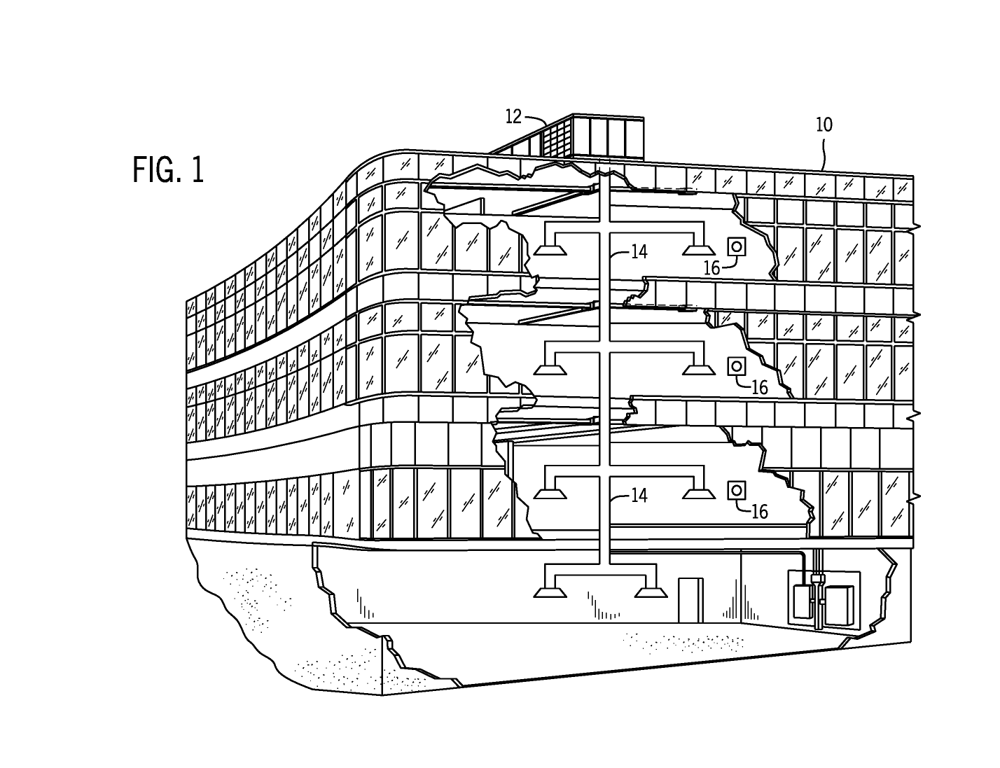

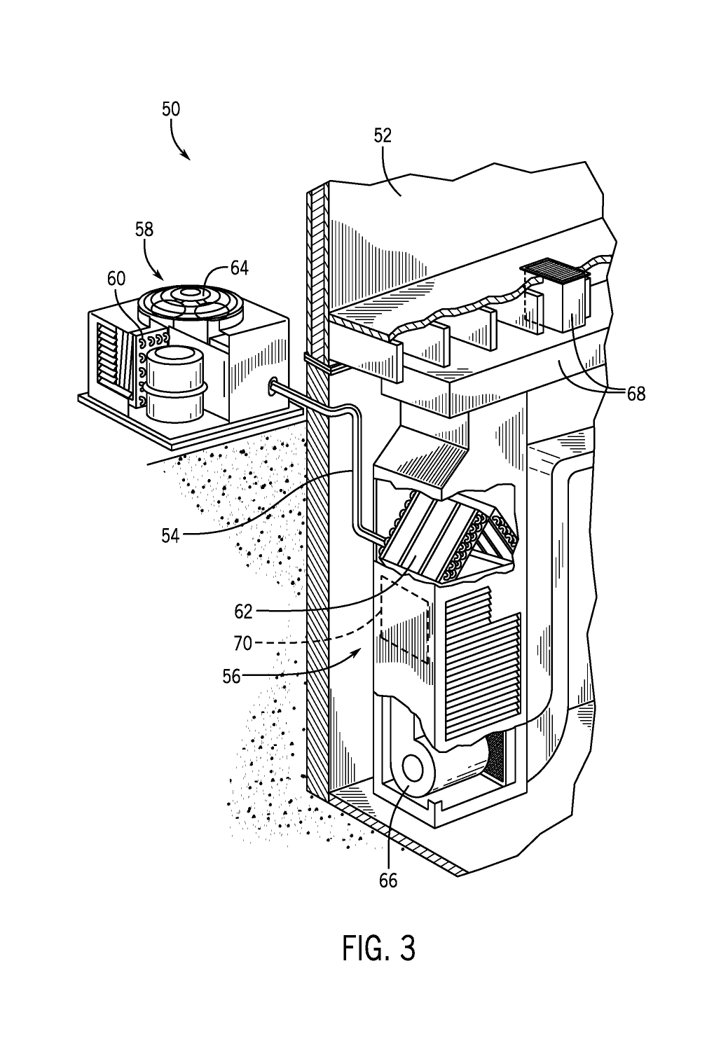

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12 or a conditioned air unit. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may include a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

In any case, the HVAC unit 12 may be an air cooled device that implements a refrigeration cycle to provide conditioned air to the building 10. For example, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the air is conditioned, the HVAC unit 12 may supply the conditioned air to the building 10 via ductwork 14 extending throughout the building 10 from the HVAC unit 12. For example, the ductwork 14 may extend to various individual floors or other sections of the building 10. In some embodiments, the HVAC unit 12 may include a heat pump that provides both heating and cooling to the building 10, for example, with one refrigeration circuit implemented to operate in multiple different modes. In other embodiments, the HVAC unit 12 may include one or more refrigeration circuits for cooling an air stream and a furnace for heating the air stream.

A control device 16, one type of which may be a thermostat, may be used to designate the target temperature or temperature setpoint of the conditioned air. The control device 16 also may be used to control the flow of air through the ductwork 14. For example, the control device 16 may be used to regulate operation of one or more components of the HVAC unit 12 or other components, such as dampers and/or fans, within the building 10 that may control flow of air through and/or from the ductwork 14. In some embodiments, other devices may be included in the system, such as pressure and/or temperature transducers or switches that sense the temperatures and pressures of the supply air, return air, and/or the like. Moreover, the control device 16 may include computer systems that are integrated with or separate from other building control or monitoring systems, and even systems that are remote from the building 10.

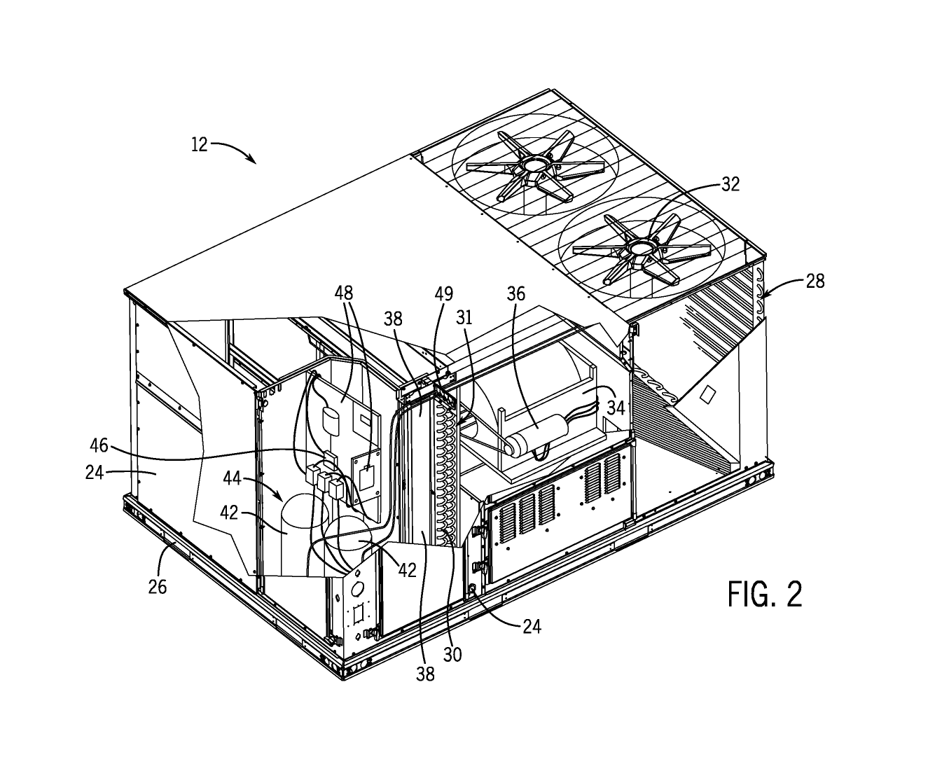

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, and/or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 to provide structural support and/or protect internal components from environmental contaminants and/or other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and/or the like. Together, the heat exchangers 28 and 30 may implement a thermal cycle in which the refrigerant undergoes phase changes and/or temperature changes as it flows through the heat exchangers 28 and 30 to produce heated and/or cooled air.

For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 may draw air from the environment through the heat exchanger 28. Air may be heated and/or cooled as the air flows through the heat exchanger 28 before being released back to the environment surrounding the rooftop unit 12. A blower assembly 34, powered by a motor 36, may draw air through the heat exchanger 30 to heat or cool the air. The heated or cooled air may be directed to the building 10 via the ductwork 14 that is connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to reduce likelihood of contaminants contacting the heat exchanger 30.

The HVAC unit 12 also may include other equipment for implementing the thermal cycle. Compressors 42 may increase the pressure and/or temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and/or devices may be included in the HVAC unit 12, such as a solid-core filter drier, a drain pan, a disconnect switch, an economizer, pressure switches, phase monitors, and humidity sensors, among other things.

The HVAC unit 12 may receive electrical power via a terminal block 46. For example, a high voltage power source may be connected to the terminal block 46 to power the equipment. The operation of the HVAC unit 12 may be governed and/or regulated by a control board 48. The control board 48 may include control circuitry connected to a thermostat, a sensor, and/or an alarm. One or more of these components may be referred to herein separately or collectively as the control device 16. The control circuitry may be implemented to control operation of the equipment, provide alarms, and/or monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated air to a residential structure, cooled air to the residential structure, outside air for ventilation, and/or provide improved indoor air quality (IAQ) through devices, such as ultraviolet lights and/or air filters. In the illustrated embodiment, the residential heating and cooling system 50 is a split HVAC system.

In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud, for example, to protect the system components and/or to prevent leaves, other debris, or other contaminants from entering the unit. The refrigerant conduits 54 may transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner or a cooling mode, a heat exchanger 60 in the outdoor unit 58 may serve as a condenser for re-condensing vaporized refrigerant flowing from the indoor unit 56 to the outdoor unit 58 via one of the refrigerant conduits 54. In these applications, a heat exchanger 62 of the indoor unit may function as an evaporator. Specifically, the heat exchanger 62 may receive liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner or cooling mode, the air is heated by the heat exchanger 60 within the outdoor unit 58 exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52.

The overall system operates to maintain a desired temperature as set by a system controller. When the temperature sensed inside the residence 52 is higher than the setpoint on the thermostat, or the setpoint plus a small amount, the residential heating and cooling system 50 may become operative to refrigerate or cool additional air for circulation through the residence 52. When the temperature reaches the setpoint, or the setpoint minus a small amount, the residential heating and cooling system 50 may stop the refrigeration cycle temporarily.

The residential heating and cooling system 50 may also operate as a heat pump or heating mode. When operating as a heat pump or a heating mode, the roles of heat exchangers 60 and 62 may be reversed. That is, the heat exchanger 60 of the outdoor unit 58 may serve as an evaporator to evaporate refrigerant and thereby cool air entering the outdoor unit 58 as the air passes over outdoor the heat exchanger 60. Additionally, the indoor heat exchanger 62 may receive a stream of air blown over it and heat the air by condensing the refrigerant.

In some embodiments, the indoor unit 56 may include a furnace system 70. For example, the indoor unit 56 may include the furnace system 70 when the residential heating and cooling system 50 is not implemented to operate as a heat pump. The furnace system 70 may include a burner assembly and heat exchanger, among other components, inside the indoor unit 56. Fuel may be provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

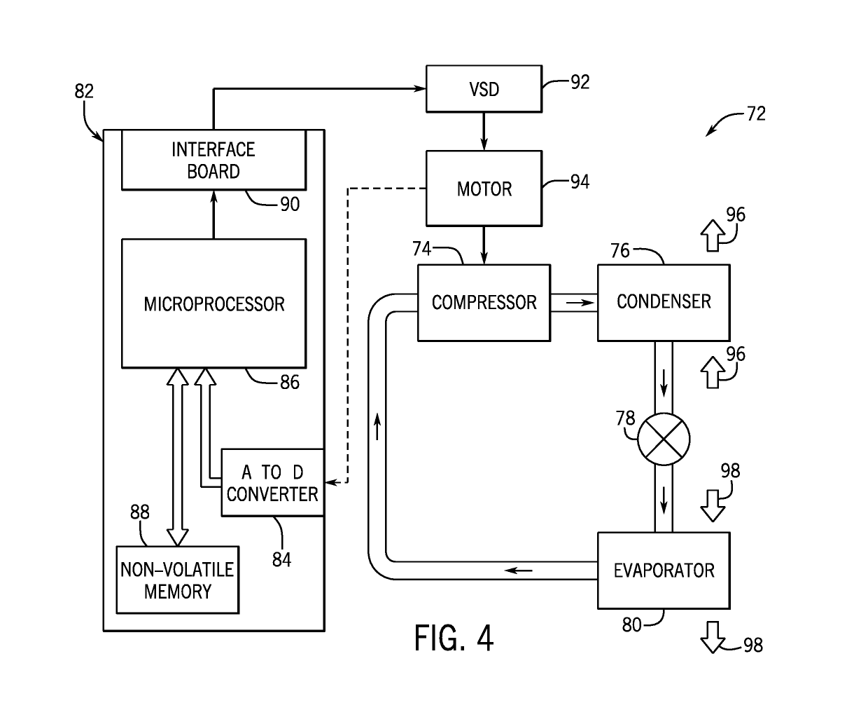

FIG. 4 is an embodiment of a vapor compression system 72 that can be used in any of the systems described above. The vapor compression system 72 may circulate a refrigerant through a circuit starting with a compressor 74. The circuit may also include a condenser 76, one or more expansion valves or expansion devices 78, and an evaporator 80. The vapor compression system 72 may further include a control panel 82 that has an analog to digital (A/D) converter 84, a microprocessor 86, non-volatile memory 88, and/or an interface board 90. The control panel 82 and its components may regulate operation of the vapor compression system 72 based on feedback, for example, received from an operator, sensors of the vapor compression system 72, and/or the like.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. In some embodiments, the VSD 92 may receive alternating current (AC) power having a particular fixed line voltage and fixed line frequency from an AC power source and provide electrical power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 may compress a refrigerant vapor and deliver the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant may exit the evaporator 80 and return to the compressor 74 by a suction line to complete the cycle.

In some embodiments, the vapor compression system 72 may further include a reheat coil in addition to the evaporator 80. For example, the reheat coil may be positioned downstream of the evaporator 80 relative to the supply air stream 98 and reheat the supply air stream 98 when the supply air stream 98 is overcooled, for example, to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC system. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

The description above with reference FIGS. 1-4 is intended to be illustrative of the context of the present disclosure. The techniques of the present disclosure may update features of the description above. In particular, as will be discussed in more detail below, a barcode may be dynamically generated, for example, by a thermostat to facilitate pairing the thermostat with a mobile device and/or providing additional information relevant to installation of the thermostat, such as the information related to the indoor unit and/or the outdoor unit. At least in some instances, generating and displaying a barcode, such as a Quick Response (QR) code, may facilitate improving thermostat installation processes.

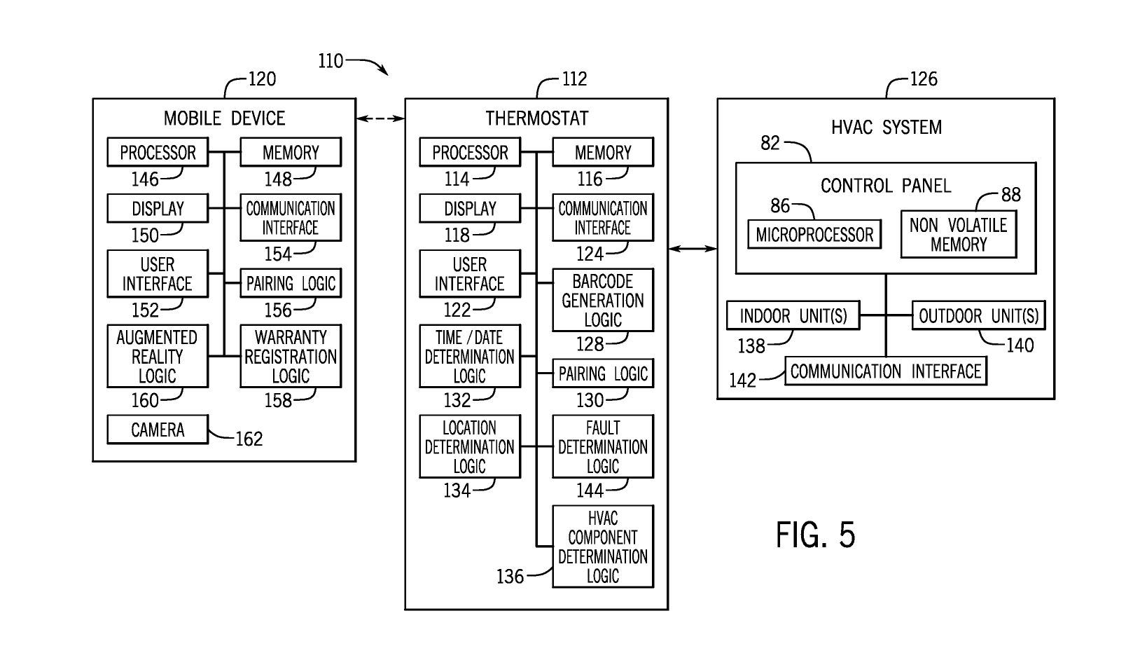

To help illustrate, a block diagram of a system 110 that dynamically generates a barcode, such as a Quick Response (QR) code, to facilitate installation of a thermostat 112 or addresses faults in an HVAC system 126 or a conditioned air system, in accordance with an embodiment of the present disclosure, is shown in FIG. 5. As discussed above, the thermostat 112, as the control device 16, may designate the target temperature or temperature setpoint for conditioned air and/or control the flow of air through the ductwork 14. The thermostat 112 may include a processor 114 that may control the thermostat 112 and a memory 116 communicatively coupled to the processor 114 that may store information associated with the thermostat 112, including instructions to control the thermostat 112.

The thermostat 112 may also include a display 118 that outputs information to be viewed by the homeowner. For example, the display 118 may display a barcode generated by the thermostat 112 for the homeowner to scan using a mobile device 120. The thermostat 112 may include a user interface 122 that enables the thermostat 112 to receive inputs from the homeowner and/or to provide information to the homeowner. In some embodiments, the user interface 122 may be provided via the display 118, which may be in the form of a touchscreen. Additionally or alternatively, the user interface 122 may include buttons, dials, a keypad, a trackpad, or the like. Typically, the user interface 122 may enable the homeowner to adjust a target temperature for a room or building and the display 118 may show or a display a visual representation of the target temperature and/or the current temperature in the room or building.

The thermostat 112 may include a communication interface 124 communicatively coupled to the processor 114 that may enable the thermostat 112 to send and receive signals to and from, for example, an HVAC system 126. The communication interface 124 may also enable the thermostat 112 to communicate to another electronic device, such as the mobile device 120, via a communication network.

In some embodiments, the thermostat 112 may also include barcode generation logic 128 that may dynamically generate a barcode based on an entry key or serial number of the thermostat 112. The barcode may be in any suitable format, including a Quick Response (QR) code. The barcode generation logic 128 may also dynamically generate the barcode based on any suitable other information, such as time/date information, geographical location information, information associated with components of the HVAC system 126, information related to registering for a warranty for the thermostat 112, and/or warranty information of the components of the HVAC system 126, for example, when the thermostat 112 is initially powered on by the homeowner. In some embodiments, the barcode generation logic 128 may generate the barcode to include a unique identification key that enables a secure manner for pairing the mobile device 120 with the thermostat 112.

It should be understood that the use of the term “logic” in the present disclosure may refer to any suitable implementation or medium, such as in hardware or circuitry and/or software or one or more software applications. In other words, the barcode generation logic 128 may be implemented as hardware, software, or a combination of hardware and software elements.

The thermostat 112 may include pairing logic 130 that may enable the thermostat 112 to pair and/or authorize communication with another electronic device, such as the mobile device 120. For example, the pairing logic 130 may enable the thermostat 112 to communicate with the mobile device 120 after the mobile device 120 scans a barcode generated by the barcode generation logic 128 and displayed on the thermostat. In some embodiments, the mobile device 120 may request authorization from the thermostat 112. The request for authorization sent by the mobile device 120 may include the entry key and/or the serial number scanned from the barcode. The pairing logic 130 may authorize the mobile device 120 based on receiving any suitable authorization data, such as the entry key and/or the serial number. In some embodiments, the request for authorization sent by the mobile device 120 may include a unique identification key scanned from the barcode that enables a secure manner for pairing the mobile device 120 with the thermostat 112.

The thermostat 112 may also include time/date determination logic 132 that may determine a current time and/or a current date. For example, when installing the thermostat 112, the time/date determination logic 132 may determine a time and/or a date associated with when the thermostat 112 was initially powered on, when the barcode generation logic 128 generated the barcode, when the thermostat 112 pairs with the mobile device 120, and/or the like. This may be particularly useful for registering a warranty, which may be triggered based on, for example, a time/date of initial operation of the thermostat 112. For example, the barcode generated by the barcode generation logic 128 may include the time/date of initial power on of the thermostat 112, for example, to facilitate warranty registration via the mobile device 120.

Similarly, the thermostat 112 may include location determination logic 134 that may determine a geographical location of the thermostat 112. For example, when installing the thermostat 112, the location determination logic 134 may determine a geographical location associated with where the thermostat 112 was initially powered on, where the barcode generation logic 128 generated the barcode, where the thermostat 112 pairs with the mobile device 120, and/or the like. This may be particularly useful for registering a warranty, which may include, for example, entering a geographical location of where the thermostat 112 was initial turned on. For example, the barcode generated by the barcode generation logic 128 may include the geographical location of where initial power on of the thermostat 112 occurred, for example, to facilitate warranty registration via the mobile device 120.

The thermostat 112 may also include HVAC component determination logic 136 or conditioned air determination logic that may determine components or conditioned air equipment, such as indoor unit 138 and/or outdoor units 140, of the HVAC system 126 and associated information or parameters. For example, when the thermostat 112 is communicatively coupled to the HVAC system 126, the HVAC component determination logic 136 may request identification information, such as model numbers, entry keys, and/or serial numbers, of the components of the HVAC system 126, for example, directly from the components and/or from the microprocessor 86 of the HVAC system 126. The microprocessor 86 may send the identification information of the components back to the HVAC component determination logic 136, for example, to enable the HVAC system 126 to store the identification information in the non-volatile memory 88. Furthermore, the HVAC component determination logic 136 may determine any other suitable information associated with the components of the HVAC system 126, such as warranty information, maintenance history, fault frequency, fault history, operational characteristics, parameter settings, setup information, and/or the like, for the indoor unit 138 and/or the outdoor unit 140.

In some embodiments, the warranty information of a component of the HVAC system 126 may include whether the component is registered for a warranty, when the warranty was registered, how long the warranty has been active, how much longer the warranty is available, the term of the warranty, whether the warranty is active, whether the warranty is expired, whether an extended warranty is available, whether an extended warranty is active, and/or the like. Additionally, in some embodiments, the maintenance history of a component of the HVAC system 126 may include an age or lifetime of the component, when maintenance was performed on the component, when maintenance is due for the component, when the component was previously replaced, and/or the like. Furthermore, in some embodiments, the fault frequency of a component of the HVAC system 126 may include whether the component has undergone a fault in its lifetime, how many faults the component has undergone, how often the component undergoes a fault, and/or the like.

In some embodiments, the fault history of a component of the HVAC system 126 may include the types of faults the component has undergone, when the components has undergone a fault, the severity of faults the component has undergone, and/or the like. Additionally, in some embodiments, the operational characteristics of a component of the HVAC system 126 may include output values of the component, output values of other components in the HVAC system 126 when the component is operating, and/or the like. Furthermore, in some embodiments, the parameter settings of a component of the HVAC system 126 may include the settings of the component set by a manufacturer, an HVAC system installer, or the homeowner. The setup information of a component in the HVAC system 126 may include initial setup settings of the component, modifications performed on the settings, and/or the like.

As depicted, the thermostat 112 may also include fault determination logic 144 that may determine faults occurring in HVAC system 126, and more specifically, faults occurring in the components of the HVAC system 126. For example, if an indoor unit 138 has a sensor failure, the microprocessor 86 of the HVAC system 126 may receive indication of a sensor failure in the indoor unit 138. Additionally, in some embodiments, the fault determination logic 144 may also determine fault frequency and/or fault history of the components in the HVAC system 126, for example, based on current and/or past faults

The HVAC system 126 may include any suitable HVAC system, such as those described above. As described in FIG. 4, the HVAC system 114 may include the control panel 82 that regulates operation of the HVAC system 126. The control panel 82 may include the microprocessor 86 and non-volatile memory 88. The HVAC system 126 may further include the communication interface 142 communicatively coupled to the control panel 82 that may enable the HVAC system 126 to send and receive signals to and from, for example, the thermostat 112. The HVAC system 126 may include one or more indoor units 138, such as an air handler, a furnace, a coil, and/or the like. The HVAC system 126 may also include one or more outdoor units 140, such as a heat pump, an air conditioning unit, and/or the like.

The mobile device 120 may be any suitable electronic communication device, such as a smartphone, a wearable device, a tablet, a laptop, a personal computer, and the like. The mobile device 120 may be external to the thermostat 112 and/or the HVAC system 126. For example, the mobile device 120 may be operated by the homeowner and used to control the thermostat 112 once paired with the thermostat 112. The mobile device 120 may include a processor 146 that may control the mobile device 120 and a memory 148 communicatively coupled to the processor 146. In some embodiments, the memory may store information associated with the mobile device 120, for example, including instructions executable by the processor 146 to control operation of the mobile device 120 and/or the thermostat 112.

The mobile device 120 may also include a display 150 that outputs information to be viewed by the homeowner. For example, the display 150 may display information related to controlling the thermostat 112, such as the temperature desired by the homeowner and/or the current temperature in a room or building. The mobile device 120 may include a user interface 152 may enable the homeowner to control the thermostat 112 and/or receive information from the thermostat 112. In some embodiments, the user interface 152 may be provided via the display 150, which may be in the form of a touchscreen. Additionally or alternatively, the user interface 152 may include buttons, dials, a keypad, a trackpad, or the like. Typically, the user interface 152 may enable the homeowner to adjust a target temperature or temperature setpoint for a room or building.

The mobile device 120 may include a communication interface 154 communicatively coupled to the processor 146 that may enable the mobile device 120 to send and receive signals to and from, for example, the thermostat 112. The communication interface 154 may also enable the mobile device 120 to communicate to another electronic device, such as the thermostat 112, via a communication network.

As depicted, the mobile device 120 may include pairing logic 156 that may enable the mobile device 120 to pair communication with another electronic device, such as the thermostat 112. For example, the pairing logic 156 may enable the mobile device 120 to communicate with the thermostat 112 after the mobile device 120 scans a barcode generated by the barcode generation logic 128 and displayed by the display 118 on the thermostat 112. In some embodiments, the mobile device 120 may request authorization from the thermostat 112. The request for authorization may include sending the entry key and/or the serial number scanned from the barcode, or any other suitable authorization data.

In some embodiments, the mobile device 120 may also include warranty registration logic 158 that may enable the mobile device 120 to register a warranty for any suitable product, such as the thermostat 112 and/or components of the HVAC system 126. For example, the warranty registration logic 158 may receive information related to the suitable product, such as the entry key, the serial number, the model number, a purchase date, a first operation date, a geographical location, and/or the like. Additionally, the warranty registration logic 158 may send or transmit the information, for example, to a website of the manufacturer of the suitable product via the communication interface 154. In some embodiments, the warranty registration logic 158 may additionally or alternatively register a warranty for an indoor unit 137 and/or an outdoor unit 140 of the HVAC system 126 that has not yet been registered. In other words, the HVAC component determination logic 136 may determine which indoor units 137 or outdoor units 140 of the HVAC system 126 have not previously had their warranties registered.

Additionally, in some embodiments, the mobile device 120 may include augmented reality logic 160 that generates a perspective view of a physical, real-world, environment where elements are augmented by computer-generated perceptual information. The augmented reality logic 160 may be particularly useful in addressing faults. For example, based on fault information determined by the fault determination logic 144, the augmented reality logic 160 may generate an augmented reality that identifies the specific component in which the fault occurs and provide steps to address or patch the fault. In particular, the augmented reality may overlay component identifiers and repair or other suitable actions when viewing the HVAC system 126, in part or in whole, using the display 150 of mobile device 120, for example, when a camera 162 of the mobile device 120 is pointed toward a corresponding portion or components of the HVAC system 126. The camera 162 may include any suitable device of the mobile device 120 that enables the homeowner to view the HVAC system 126, in part or in whole, on the display 150 of the mobile device 120. As such, the camera 162 may include an image capture device, a video capture device, and/or the like.

The processors 114, 146, 86 of the thermostat 112, the mobile device 120, and the HVAC System 126, respectively, may execute software programs and/or instructions relating to determining components of the HVAC systems, dynamically generating barcodes, registering for warranties, and/or the like. Moreover, the processors 114, 146, 86 may include one or more microprocessors, one or more “general-purpose” microprocessors, one or more special-purpose microprocessors, one or more application specific integrated circuits (ASICS), or some combination thereof. For example, the processors 114, 146, 86 may include one or more reduced instruction set (RISC) processors.

The memory devices 116, 148, 88 of the thermostat 112, the mobile device 120, and the HVAC System 126, respectively, may store information such as control software, look up tables, configuration data, and/or the like. In some embodiments, the memory devices 116, 148, 88 may include tangible, non-transitory, machine-readable-media, such as volatile memory, random access memory (RAM), nonvolatile memory, and/or read-only memory (ROM). The memory devices 116, 148, 88 may include one or more nonvolatile storage devices that may include read-only memory (ROM), flash memory, a hard drive, and/or any other suitable optical, magnetic, or solid-state storage medium. The memory devices 116, 148, 88 may store a variety of information and may be used for various purposes. For example, the memory devices 116, 148, 88 may store machine-readable and/or processor-executable instructions as firmware or software for the processors 114, 146, 86 to execute, such as instructions relating to determining components of the HVAC systems, dynamically generating barcodes, registering for warranties, and the like.

The communication interfaces 124, 154, 142 of the thermostat 112, the mobile device 120, and the HVAC System 126, respectively, may enable communication with any suitable communication network. For example, the communication interfaces 124, 154, 142 may enable the thermostat 112, the mobile device 120, and the HVAC System 126, respectively, to communicate via any suitable wired and/or wireless networks, for example, wiring terminals, mobile networks, WiFi networks, LAN, WAN, Internet, and/or the like. In this manner, the communication interfaces 124, 154, 142 may enable the thermostat 112, the mobile device 120, and the HVAC System 126 to communicate with each other.

The user interfaces 122, 152 of the thermostat 112 and the mobile device 120, respectively, may enable the thermostat 112 and the mobile device 120 to display output to and/or receive input from the homeowner. For example, the user interfaces thermostat 112 and the mobile device 120 may include any suitable input and output devices, such as displays, touchscreens, styluses, keypads, and/or the like, to enable the homeowner to receive information and perform operations associated with installing the thermostat 112.

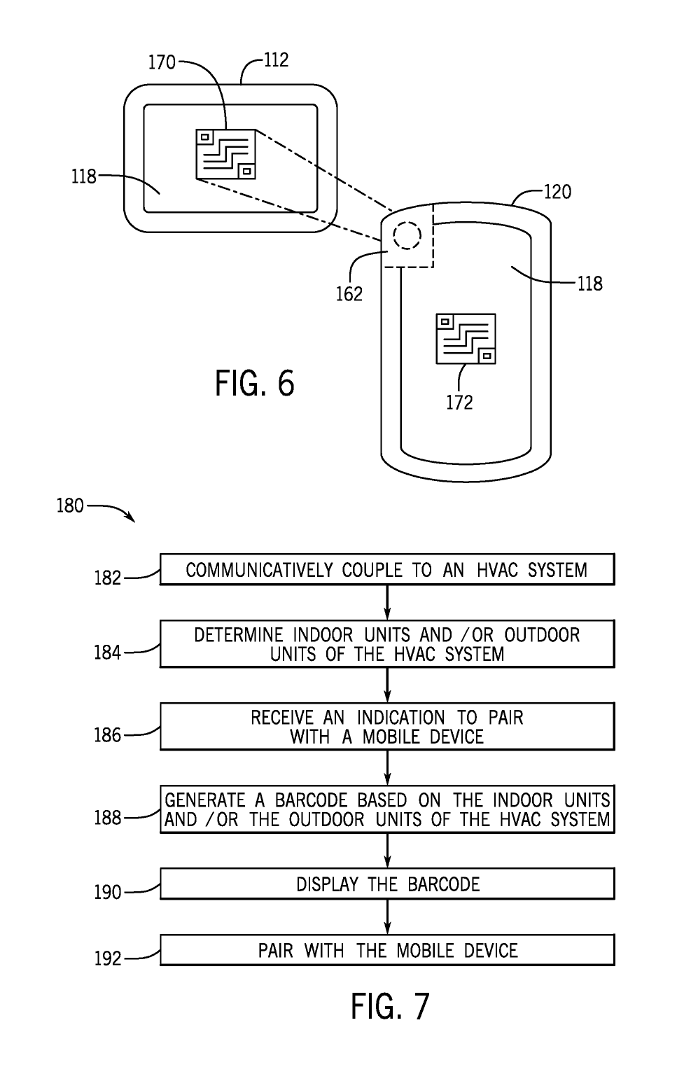

With the foregoing in mind, FIG. 6 is an example of the mobile device 120 scanning a barcode 170 displayed on the display 118 of the thermostat 112 of FIG. 5, in accordance with an embodiment of the present disclosure. In particular, the barcode generation logic 128 may generate the barcode 170 or a QR code, for example, based on an entry key or serial number of the thermostat 112, components of the HVAC system 126, time/date associated with installing the thermostat 112, location of the thermostat 112, and the like. The homeowner may then scan the barcode 170, for example, using the camera 162 of the mobile device 120. As illustrated, an image representation 172 of the barcode 170 may be displayed on the display 118 of the mobile device 120 when the homeowner scans the barcode 170 with the mobile device 120.

With the foregoing in mind, FIG. 7 is a flow diagram of a process 180 for installing a thermostat 112 by dynamically generating the barcode 170, in accordance with an embodiment of the present disclosure. The process 180 may be performed by any suitable device that may communicatively couple to the HVAC system 126, determine components of the HVAC system 126, dynamically generate and display the barcode 170, and pair with the mobile device 120. While the process 180 is described using steps in a specific sequence, it should be understood that the present disclosure contemplates that the described steps may be performed in different sequences than the sequence illustrated, and certain described steps may be skipped or not performed altogether. In some embodiments, the process 180 may be implemented by executing instructions stored in a tangible, non-transitory, computer-readable medium, such as the memory 116, using a processor, such as the processor 114.

As illustrated, the processor 114 may communicatively couple, at process block 182, to the HVAC system 126. In particular, the processor 114 of the thermostat 112 may instruct the communication interface 124 of the thermostat 112 to communicatively couple to the communication interface 142 of the HVAC system 126. For example, the processor 114 of the thermostat 112 may communicatively couple to the communication interface 142 of the HVAC system 126 via one or more wiring terminals.

The processor 114 may then determine, at process block 184, the indoor units 138 and/or the outdoor units 140 of the HVAC system 126. In some embodiments, the processor 114 may instruct the HVAC component determination logic 136 of the thermostat 112 to determine the indoor units 138 and the outdoor units 140 of the HVAC system 126. Moreover, the processor 114 may instruct the HVAC component determination logic 136 to determine identification information, such as model numbers, entry keys, and/or serial numbers, of the indoor units 138 and the outdoor units 140. In some embodiments, the processor 114 may instruct the HVAC component determination logic 136 to determine other information associated with the components of the HVAC system 126, such as warranty information, maintenance history, fault frequency, fault history, operational characteristics, parameter settings, setup information, and/or the like.

The processor 114 may receive, at process block 186, an indication to pair with the mobile device 120. For example, during installation, the thermostat 112 may display an option for pairing the mobile device 120 on the display 118, for example, to enable control of the thermostat 112 via the mobile device 120. When the option is selected, the processor 114 of the thermostat 112 may receive an indication to pair the thermostat with the mobile device 120.

The processor 114 may then generate, at process block 188, the barcode 170 based on at least an indoor unit 138 or an outdoor unit 140 implemented in the HVAC system 126. For example, the processor 114 may instruct the barcode generation logic 128 to generate the barcode 170 to indicate the entry key and/or serial number of the thermostat 112. Additionally or alternatively, the processor 114 may instruct the barcode generation logic 128 to generate the barcode 170 to include information associated with the indoor units 138 and/or the outdoor units 140. For example, the processor 114 may instruct the barcode generation logic 128 to generate the barcode 170 to indicate identification information, such as model numbers, entry keys, and/or serial numbers, of the indoor units 138 and/or the outdoor units 140. In some embodiments, the processor 114 may instruct the barcode generation logic 128 to generate the barcode 170 to indicate other information associated with the indoor units 138 and/or the outdoor units 140, such as warranty information, maintenance history, fault frequency, fault history, operational characteristics, parameter settings, setup information, and the like. In some embodiments, the processor 114 may instruct the barcode generation logic 128 to generate the barcode 170 to include a unique identification key that facilitates securely pairing the mobile device 120 and the thermostat 112.

The processor 114, at process block 190, may instruct the thermostat 112 to display the barcode 170 on its display 118. For example, the processor 114 may instruct the user interface 122 to display the barcode 170 on the display 118. In this manner, the barcode 170 may be scanned, for example, by a homeowner using the camera 162 of the mobile device 120, as illustrated in FIG. 6.

The processor 114 may then pair, at process block 192, the thermostat with the mobile device 120. For example, the processor 114 may instruct the pairing logic 130 of the thermostat 112 to pair with the pairing logic 156 of the mobile device 120. In some embodiments, after scanning the barcode 170, the mobile device 120 may send a pairing request to the thermostat 112 via its pairing logic 156. The pairing request may indicate information received based on scanning the barcode 170, such as the entry key and/or the serial number of the thermostat 112. Additionally or alternatively, the pairing request may indicate a unique identification key scanned from the barcode 170, for example, which facilitates securely pairing the thermostat 112 with the mobile device 120.

Once paired, the homeowner may use the mobile device 120 to, for example, register a warranty for the newly installed thermostat 112 using the warranty registration logic 158. For example, when the barcode 170 indicates the serial number of the thermostat 112, the time/date of when the thermostat 112 was initially turned on, and/or the location information of the thermostat 112, the processor 146 of the mobile device 120 may instruct the warranty registration logic 158 to register for the warranty, for example, by supplying or inputting the serial number, the time/date of when the thermostat 112 was initially turned on, and/or the location information of the thermostat 112 to a website of the thermostat's manufacturer via its communication interface 154. Additionally or alternatively, when the barcode 170 indicates information related to a serial number of an outdoor unit 140 of the HVAC system 126 and an indication that a warranty for the outdoor unit 140 has not yet been registered, the processor 146 of the mobile device 120 may instruct the warranty registration logic 158 to register a warranty for the outdoor unit 140 using the serial number of the outdoor unit 140.

In this manner, the process 180 may dynamically generate the barcode 170 to provide additional information relevant to operation of thermostat 170, such as the information related to the indoor units 138 and/or the outdoor units 140, which, at least in some instances, may facilitate improving deployment of the HVAC system 126. Dynamically generating the barcode 170 may also enable the thermostat 112 to facilitate addressing faults of the HVAC system 126 and/or components in the HVAC system 126, repairing the HVAC system 126, performing maintenance on the HVAC system 126, and/or the like.

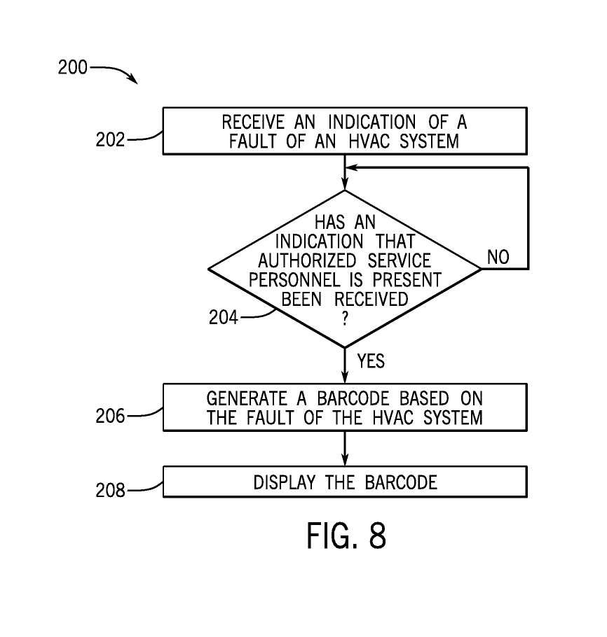

With this in mind, FIG. 8 is a flow diagram of a process 200 for indicating faults in an HVAC system 126 by dynamically generating a barcode 170, in accordance with an embodiment of the present disclosure. The process 200 may be performed by any suitable device that may receive an indication of a fault in the HVAC system 126, generate the barcode 170 based on the fault, and display the barcode 170. While the process 200 is described using steps in a specific sequence, it should be understood that the present disclosure contemplates that the described steps may be performed in different sequences than the sequence illustrated, and certain described steps may be skipped or not performed altogether. In some embodiments, the process 200 may be implemented by executing instructions stored in a tangible, non-transitory, computer-readable medium, such as the memory 116, using a processor, such as the processor 114.

As illustrated, the processor 114 may receive, at process block 202, an indication of a fault of the HVAC system 126. In some embodiments, the processor 114 of the thermostat 112 may instruct the fault determination logic 144 of the thermostat 112 to determine whether there is a fault in HVAC system 126 and/or whether there is a fault occurring in specific components of the HVAC system 126. For example, if an indoor unit 138 has a sensor failure, the microprocessor 86 of the HVAC system 126 may receive a fault indicating sensor failure of the indoor unit 138. The fault determination logic 144 may, for example, send a request to the HVAC system 126 for current or past faults and receive an indication of the fault indicating sensor failure of the indoor unit 138. In some embodiments, the fault determination logic 144 may also determine fault frequency and/or fault history of the components of the HVAC system 126.

The processor 114 may then determine, at process block 204, whether an indication that authorized service personnel is present has been received. That is, in some instances, the thermostat 112 may only display the barcode indicating the fault that the HVAC system 126 is undergoing to an authorized service personnel. This might be because, given knowledge of the fault, an unqualified homeowner may attempt to repair the HVAC system 126 himself or herself, possibly inadvertently reducing the lifetime of the HVAC system 126. The indication that the authorized service personnel is present may be provided by pairing a mobile device, such as mobile device 120, of the authorized service personnel with the thermostat 112, for example, via the pairing logic 130, entering a code via the user interface 122 of the thermostat 112, and/or the like. In some embodiments, the processor 114 may determine that the authorized service personnel is within a threshold distance, such as two feet, five feet, ten feet, and the like, of the thermostat 112. In particular, the processor 114 may determine the indication that the authorized service personnel is present has been received when the processor 114 determines the mobile device 120 of the authorized service personnel is within the threshold distance.

As such, if the indication that the authorized service personnel is present has not been received, then the process 200 repeats process block 204, for example, until the indication has been received. In some embodiments, the thermostat 112 may display a high-level indication of the fault on the display 118 or send the high-level indication to the mobile device 120, for example, of the homeowner. The high-level indication may include an alert, a message, a visual indicator, and/or the like, which indicates that a fault has occurred. In some embodiments, the high-level indication may not identify the fault itself. For example, the high-level indication may include a message which indicates that a fault has occurred, that the heating function of the HVAC system 126 is not fully functional, that the homeowner should contact the authorized service personnel, and/or the like.

When the indication that the authorized service personnel is present has been received, the processor 114 may generate, at process block 206, the barcode 170 based on the fault of the HVAC system 126. That is, the processor 114 may instruct the barcode generation logic 128 to generate the barcode 170 to include any suitable information associated with the fault, such as identifying the component undergoing the fault, when the fault occurred, the fault history of the component, the fault frequency of the component, the maintenance history of the component, operating characteristics of the component, parameter settings of the component, setup information of the component, warranty information of the component, and/or similar information for other components of the HVAC system 126 that operate in conjunction with the component. For example, if the fault is a sensor failure in an indoor unit 138, the barcode generation logic 128 may generate the barcode 170 to indicate identification information for the sensor, identification information for the indoor unit 138, when the fault occurred, the fault history of the sensor, the maintenance history of the component, the operational characteristics of the indoor unit 138, warranty information of the sensor, warranty information of the indoor unit 138, and/or the like.

The processor 114, at process block 208, may instruct the thermostat to display the barcode 170 on its display 118. In particular, the processor 114 may instruct the user interface 122 to display the barcode 170 on the display 118. As such, the authorized service personnel may scan the barcode 170, for example, using the camera 162 of his or her mobile device 120, as illustrated in FIG. 6. In some embodiments, upon scanning the barcode 170, the augmented reality logic 160 of the mobile device 120 may display an overlaid view identifying components and steps to follow to address the fault on the display 150 of the mobile device 120 of the authorized service personnel. For example, the overlaid view may indicate steps to access a faulty sensor of the indoor unit 138 and/or identify where the faulty sensor is located. In some embodiments, upon scanning the barcode 170, the processor 146 may automatically indicate that the faulty component should be purchased, for example, by virtually placing the component in a shopping cart of a component supplier's website, by adding a task on a to-do list software application running on the mobile device 120 of the authorized service personnel, and/or the like.

Additionally or alternatively, the barcode generation logic 128 may generate the barcode 170 to provide information related to maintenance history, fault history, operational characteristics, parameter settings, and/or the like, for example, for maintenance purposes. That is, when the authorized service personnel performs a service check on the HVAC system 126 and provides an indication that he or she is present, the barcode generation logic 128 may generate the barcode 170 to indicate such information, for example, to a mobile device 120 when scanned by a camera 162 of the mobile device 120. In other words, upon scanning the barcode 170, the authorized service personnel may review the information via the display 150 on his or her mobile device 120. In this manner, the process 200 may dynamically generate the barcode 170 to facilitate addressing faults of the HVAC system 126), repairing the HVAC system 126, performing maintenance on the HVAC system 126, and the like.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A thermostat comprising:
fault determination logic programmed to determine that conditioned air equipment is experiencing a fault;
barcode generation logic programmed to generate a barcode based on the fault; and
an electronic display configured to display the barcode to facilitate communicating information related to the fault with an external device when the barcode is scanned by the external device.

2. The thermostat of claim 1, wherein the barcode comprises a Quick Response (QR) code.

3. The thermostat of claim 1, wherein, when a component implemented in the conditioned air equipment is experiencing the fault:
the fault determination logic is programmed to determine identity of the component that is experiencing the fault; and
the barcode generation logic is programmed to generate the barcode such that the barcode indicates the identity of the component that is experiencing the fault to the external device when scanned by the external device.

4. The thermostat of claim 3, wherein the barcode comprises an identification number associated with the component.

5. The thermostat of claim 3, wherein the component comprises an air handler, a furnace, a coil, a heat pump, an air conditioning unit, or any combination thereof.

6. The thermostat of claim 3, wherein the barcode generation logic is programmed to generate the barcode such the barcode indicates warranty information associated with the component that is experiencing the fault to the external device when scanned by the external device.

7. The thermostat of claim 1, wherein the barcode generation logic is programmed to generate the barcode such that the barcode indicates sensor data acquired when the conditioned air equipment experiences the fault to the external device when scanned by the external device.

8. The thermostat of claim 1, wherein the barcode generation logic is programmed to generate the barcode such that the barcode indicates a frequency value associated with each time the conditioned air equipment experiences the fault to the external device when scanned by the external device.

9. The thermostat of claim 1, comprising time and date determination logic programmed to determine a time and date associated with when the conditioned air equipment experiences the fault.

10. The thermostat of claim 9, wherein the barcode generation logic is programmed to generate the barcode such the barcode indicates the time and date associated with when the conditioned air equipment experiences the fault to the external device when scanned by the external device.

11. The thermostat of claim 1, comprising a camera implemented on the external device, wherein the camera is configured to scan the barcode.

12. The thermostat of claim 11, wherein the external device comprises another electronic display configured to display an augmented reality sequence based on the fault in response to the camera scanning the barcode displayed on the electronic display of the thermostat.

13. The thermostat of claim 11, wherein the external device is configured to purchase items by at least selecting the items to be placed in a virtual shopping cart, wherein a component of the conditioned air equipment associated with the fault is placed in the virtual shopping cart in response to scanning the barcode by the camera of the external device.

14. A method of determining a fault in conditioned air equipment comprising:
receiving an indication of a fault on a thermostat occurring in the conditioned air equipment;
generating a barcode based on parameters of the fault; and
displaying the barcode on the thermostat to enable determining the parameters of the fault when the barcode is scanned.

15. The method of claim 14, comprising receiving an indication that service personnel is present at the thermostat.

16. The method of claim 15, comprising displaying a high-level indication of the fault on the thermostat.

17. The method of claim 15, comprising authorizing the service personnel.

18. The method of claim 17, wherein displaying the barcode occurs in response to authorizing the service personnel.

19. The method of claim 14, wherein the barcode is configured to be scanned by a mobile device.

20. A tangible, non-transitory, computer-readable medium that stores instructions executable by a processor of a thermostat that, when executed by the processor, cause the processor to:
receive an indication of a fault occurring in a component of conditioned air equipment;
generate a barcode based on the component of the conditioned air equipment, parameters of the fault occurring in the component, or both; and
display the barcode to enable determining the component experiencing the fault, the parameters of the fault, or both, in response to scanning the barcode.

21. The computer-readable medium of claim 20, that stores instructions that, when executed by the processor, cause the processor to receive an indication that service personnel is present within a threshold distance from the conditioned air equipment.

22. The computer-readable medium of claim 20, wherein the barcode is configured to enable an external device to determine the component experiencing the fault, the parameters of the fault, or both, in response to the external device scanning the barcode.

23. The computer-readable medium of claim 20, wherein the instruction to generate the barcode comprises instructions to generate the barcode such that the barcode indicates part information of the component experiencing the fault.

24. The computer-readable medium of claim 23, wherein the part information comprises a part number, warranty information, installation history, maintenance history, fault history, or any combination thereof, of the component.
